(19) United States
(12) Patent Application Publication
(10) Pub. No.: US 2026/0019937 A1
(43) Pub. Date: Jan. 15, 2026

(54) CHANNEL SELECTING METHOD AND SYSTEM THEREOF

(71) Applicant: WNC Corporation, Hsinchu (TW)

(72) Inventors: Chih-Wei CHUNG, Hsinchu (TW); Yi-Ju YANG, Hsinchu (TW)

(21) Appl. No.: 19/256,314

(22) Filed: Jul. 1, 2025

(30) Foreign Application Priority Data
Jul. 10, 2024 (TW) 113125882

(51) Int. Cl. H04W 48/20

(52) U.S. Cl. CPC H04W 48/20

(57) ABSTRACT

A channel selecting method includes driving a controller to transmit a channel preference query message to an access point, and to configure the access point to return a plurality of channel preference values; driving the controller to determine whether a previous channel selecting time of the access point matches with a default time; driving the controller to read a channel state recording table when the previous channel selecting time matches with the default time; driving the controller to scan the communication channels to obtain a present channel information; driving the controller to update the channel preference values to generate a plurality of updated channel values according to the channel state recording table and the present channel information; and driving the controller to configure the access point to select one of the communication channels to communicate with the client according to the updated channel values.

### RELATED APPLICATIONS

This application claims priority to Taiwan Application Serial Number 113125882, filed Jul. 10, 2024, which is herein incorporated by reference.

### BACKGROUND

### Technical Field

The present disclosure relates to a channel selecting method and a system thereof. More particularly, the present disclosure relates to a channel selecting method and a system thereof of wireless communication network access point.

### Description of Related Art

The conventional mobile electronic devices connect to wireless network and transmit data. The mesh network includes a controller, a plurality of access points and clients (i.e., the mobile devices). The access points can transmit data to a client via a regular channel, or select one of the channels, which are suggested by the controller, to transmit data to the client. The conventional Auto Channel Selection (ACS) eliminates the channels which are used by other access points or suggests the access point not to transmit data via a channel with high utilization.

However, besides the channel utilization, some using situations and environment requirements are not listed in the consideration standard of the ACS. Thus, developing a channel selecting method and system thereof, which can take the using situations and environments in the consideration, are commercially desirable.

### SUMMARY

According to one aspect of the present disclosure, a channel selecting method is configured to communicate with a client. The channel selecting method includes driving a controller to transmit a channel preference query message to an access point, and to configure the access point to return a plurality of channel preference values of the access point, the channel preference values correspond to a plurality of communication channels; driving the controller to determine whether a previous channel selecting time of the access point matches with a default time, the previous channel selecting time is a time difference between a present time and a most recent time when the access point executes a channel selection; driving the controller to read a channel state recording table from a memory unit when the previous channel selecting time matches with the default time, the channel state recording table corresponds to a plurality of states of the communication channels; driving the controller to scan the communication channels to obtain a present channel information, wherein the present channel information includes a present utilization and a present interference state; driving the controller to update the channel preference values to generate a plurality of updated channel values according to the channel state recording table and the present channel information; and driving the controller to configure the access point to select one of the communication channels to communicate with the client according to the updated channel values.

According to another aspect of the present disclosure, a channel selecting system is configured to communicate with a client. The channel selecting system includes an access point, a memory unit and a controller. The memory unit includes a channel state recording table. The channel state recording table corresponds to a plurality of states of a plurality of communication channels. The controller is signally connected to the access point and the memory unit, and configured to implement a channel selecting method. The channel selecting method includes transmitting a channel preference query message to the access point, and configuring the access point to return a plurality of channel preference values of the access point, the channel preference values correspond to the communication channels; determining whether a previous channel selecting time of the access point matches with a default time, wherein the previous channel selecting time is a time difference between a present time and a most recent time when the access point executes a channel selection; reading the channel state recording table from the memory unit when the previous channel selecting time matches with the default time; scanning the communication channels to obtain a present channel information, wherein the present channel information includes a present utilization and a present interference state; updating the channel preference values to generate a plurality of updated channel values according to the channel state recording table and the present channel information; and configuring the access point to select one of the communication channels to communicate with the client according to the updated channel values.

### BRIEF DESCRIPTION OF THE DRAWINGS

The present disclosure can be more fully understood by reading the following detailed description of the embodiment, with reference made to the accompanying drawings as follows:

FIG. 1 shows a schematic view of a channel selecting system according to a first embodiment of the present disclosure.

FIG. 2 shows a flow chart of a channel selecting method according to a second embodiment of the present disclosure.

FIG. 3 shows a flow chart of the controller of the channel selecting system of FIG. 1, while collecting the transmitting information and executing channel scanning regularly.

FIG. 4 shows a flow chart of the channel selecting system of FIG. 1, while recording and analyzing the using habit of the client.

FIG. 5 shows a schematic view of a channel selecting system according to a third embodiment of the present disclosure.

FIG. 6 shows a flow chart of the controller of the channel selecting method of FIG. 2, while adjusting the channel preference value.

FIG. 7 shows a flow chart of a channel selecting method according to a fourth embodiment of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

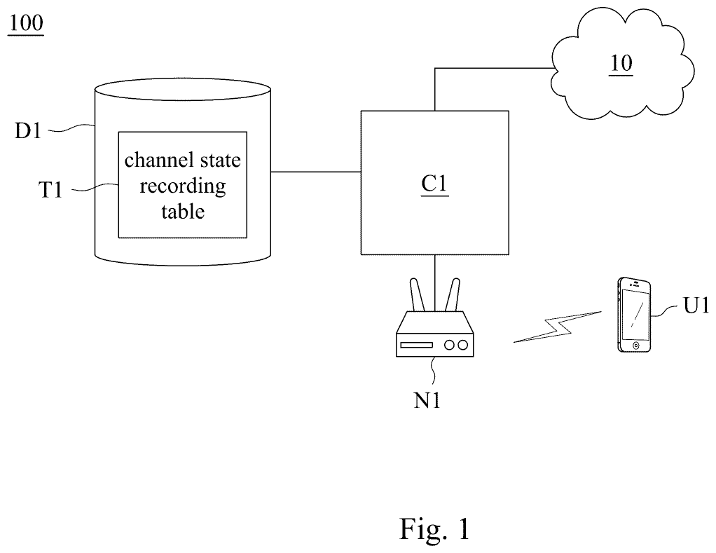

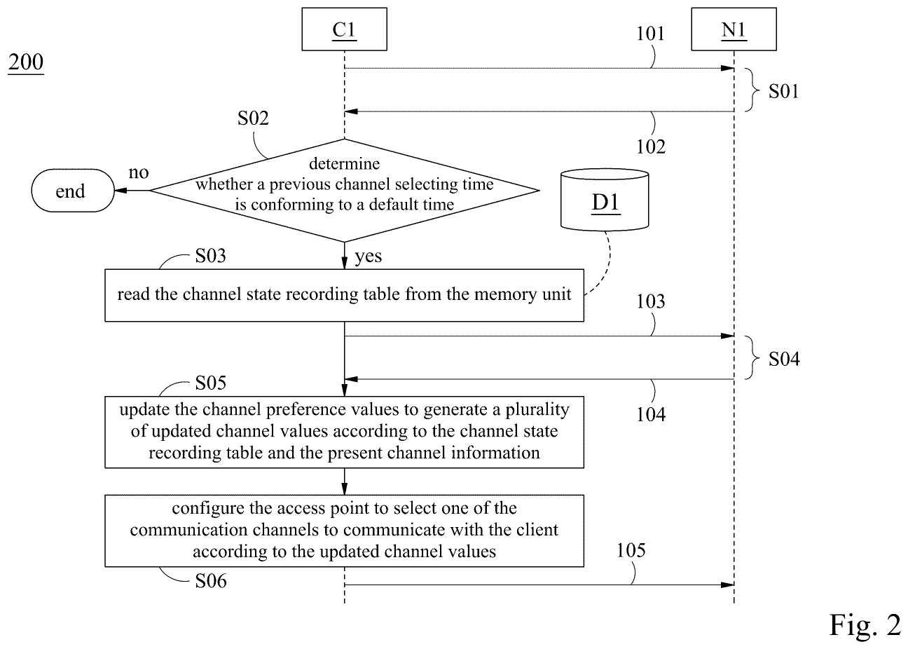

Please refer to FIG. 1 and FIG. 2. FIG. 1 shows a schematic view of a channel selecting system 100 according to a first embodiment of the present disclosure. FIG. 2 shows a flow chart of a channel selecting method 200 according to a second embodiment of the present disclosure. The channel selecting system 100 is configured to communicate with a client U1. The channel selecting system 100 includes a controller C1, an access point N1 and a memory unit D1. The memory unit D1 includes a channel state recording table T1. The channel state recording table T1 corresponds to a plurality of states of a plurality of communication channels (not shown in FIG. 1). The controller C1 is signally connected to the access point N1, the memory unit D1 and the network 10, and is configured to implement the channel selecting method 200.

In detail, the mesh network structure includes a plurality of communication channels, the controller C1 can be a controller of the mesh network structure, the access point N1 can be an agent in the mesh network structure, the memory unit D1 can include a Random Access Memory (RAM) capable to store information and instruction for the controller C1 to process or other dynamic storing device, the client U1 can be laptop, cell phone, mobile device or other electronic device connected by wireless network, but the present disclosure is not limited thereto.

In FIG. 1, the controller C1 of the mesh network structure is signally connected to the memory unit D1, the access point N1 is signally connected to the controller C1, and the client U1 is connected to the access point N1.

In FIG. 2, the channel selecting method 200 includes steps S01, S02, S03, S04, S05, S06. The step S01 includes driving the controller C1 to transmit a channel preference query message 101 to the access point N1, and to configure the access point N1 to return a channel preference query report 102. The channel preference query report 102 includes a plurality of channel preference values, and the channel preference values correspond to the communication channels. The step S02 includes driving the controller C1 to determine whether a previous channel selecting time of the access point N1 matches with a default time. The previous channel selecting time is a time difference between a present time and a most recent time when the access point N1 executes an auto channel selection. The step S03 includes driving the controller C1 to read the channel state recording table T1 from the memory unit D1 when the previous channel selecting time matches with the default time. The step S04 includes driving the controller C1 to scan the communication channels to obtain a present channel information. The step S04 includes driving the controller C1 to transmit a channel scanning request 103 and driving the access point N1 to reply a channel scanning result 104. The present channel information includes a present utilization and a present interference state. The step S05 includes driving the controller C1 to update the channel preference values to generate a plurality of updated channel values according to the channel state recording table T1 and the present channel information. The step S06 includes driving the controller C1 to configure the access point N1 to select one of the communication channels to communicate with the client U1 according to the updated channel values, and transmit a channel selecting request 105 to the access point N1.

Specifically, the channel preference values can be preference scores generated by the controller C1 according to the using state of the communication channels. Each of the communication channels corresponds to one of the channel preference values. The step S02 is performed to verify a time point when the access point N1 selected the channel previously, so as to avoid the access point N1 switching the communication channel too often. If the time point when the access point N1 selected the channel previously is too close, the step S02 is stopped. If the time point when the access point N1 selected the channel previously matches with the default time, the step S03 is performed. The step S03 is performed to read the channel state recording table T1 of the access point N1 from the memory unit D1. The channel state recording table T1 includes the channel utilization of all the communication channels previously (i.e., the previously utilization) and the state from other external interference (i.e., previous interference state). In the step S04, the controller C1 is performed to configure the access point N1 to send the channel scanning request 103 to obtain the present channel utilization and the present interference state interfered from the radar of all the communication channels. The step S05 is performed to combine the previous channel utilization and the present channel utilization of the communication channels and the previous interference state and the present interference state interfered from the radar, and update the channel preference values to generate the updated channel values. In the step S06, the controller C1 recommends the most suitable communication channel to the access point N1 according to the previous and present channel utilization and interference state of the communication channels. According to observation, the priority level of the communication channels with high utilization or the communication channels prone to be interfered by radar are usually low, and the priority level of the communication channels with low utilization or the communication channels difficult to be interfered by radar usually has high priority level. Thus, the channel selecting system 100 of the present disclosure can select the best communication channel to communicate according to the previous state and present state of the communication channels, to increase the entire efficiency of the mesh network structure.

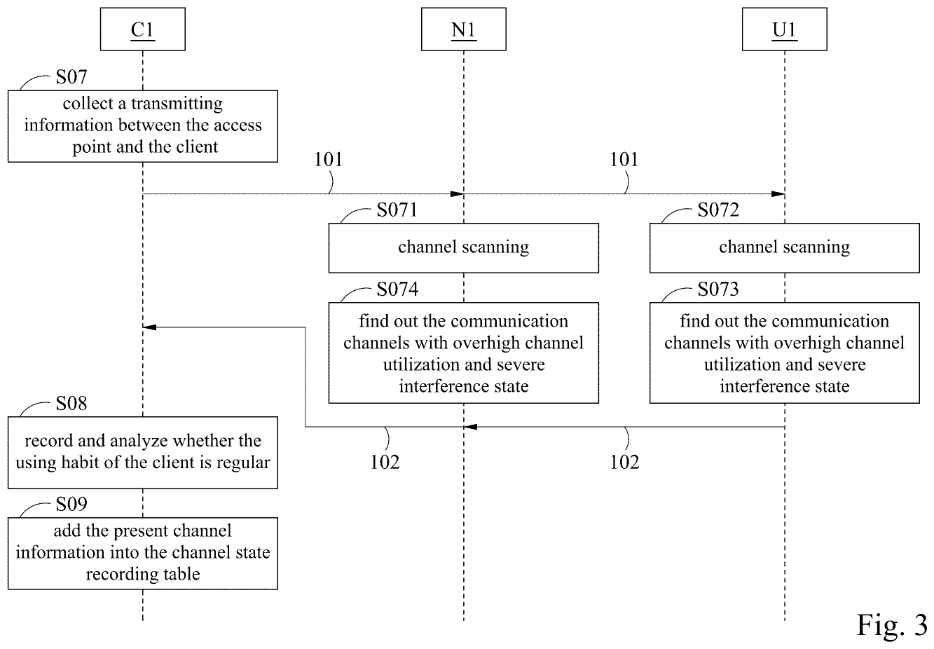

Please refer to FIG. 1 to FIG. 3. FIG. 3 shows a flow chart of the controller C1 of the channel selecting system 100 of FIG. 1, while collecting the transmitting information and executing channel scanning regularly. The channel selecting method 200 can further include steps S07, S071, S072, S073, S074, S08, S09. The controller C1 of the channel selecting system 100 can collect the transmitting information and scan the communication channels regularly via the steps S07, S071, S072, S073, S074, S08, S09. The step S07 includes driving the controller C1 to collect a transmitting information between the access point N1 and the client U1, and to transmit the channel preference query message 101 to the access point N1 and the client U1. The step S071 includes driving the access point N1 to execute channel scanning to the communication channels to obtain the present channel information of all the communication channels, which are used by the access point N1. The step S072 includes driving the client U1 to execute channel scanning to the communication channels to obtain the present channel information of all the communication channels, which are used by the access point N1. The step S073 includes finding out the communication channels with excessive channel utilization and severe interference state according to all the present channel utilizations of the client U1. The step S074 includes finding out the communication channels with excessive channel utilization and severe interference state according to all the present channel utilizations of the access point N1, combining the channel utilization, the interference state and the corresponding communication channel of the aforementioned access point N1 and the client U1 into a channel preference query report 102, and returning the channel preference query report 102 to the controller C1. The step S08 includes recording and analyzing whether the using habit of the client U1 is regular. The step S09 includes adding the present channel information into the channel state recording table T1 according to the high/low of the channel utilization of the communication channel and whether the interference state is severe. In detail, the channel state recording table T1 records some of the communication channels with higher channel utilization in a time interval, some of the communication channels with lower channel utilization in a time interval, some of the communication channels with severe interference in a time interval and some of the communication channels with minimal interference in a time interval. The step S08 is described in more detail as follow.

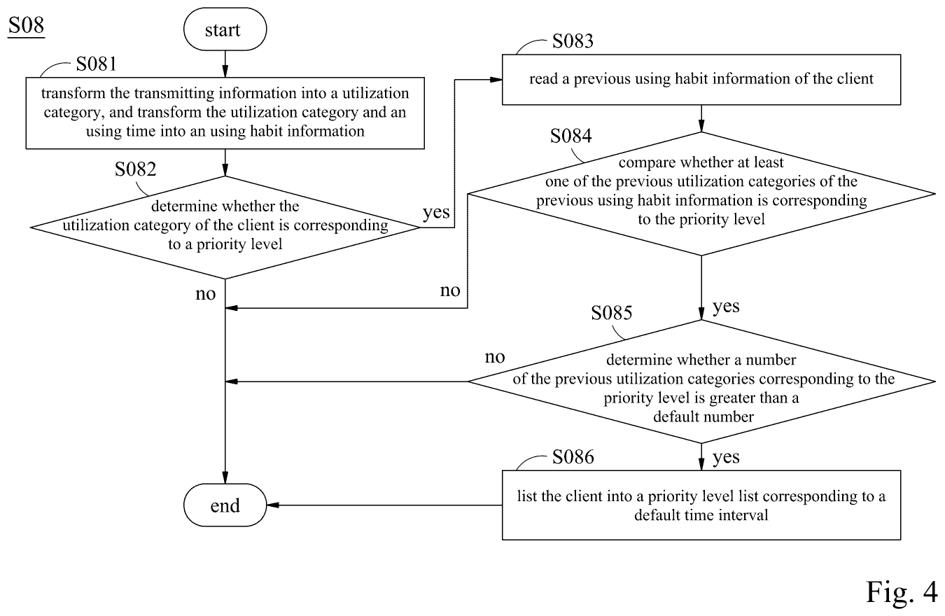

Please refer to FIG. 1 to FIG. 4. FIG. 4 shows a flow chart of the channel selecting system 100 of FIG. 1, while recording and analyzing the using habit of the client U1. The step S08 of the channel selecting method 200 can further include the steps S081, S082, S083, S084, S085, S086. The channel selecting system 100 can execute the steps S081, S082, S083, S084, S085, S086 via the controller C1. The step S081 includes driving the controller C1 to transform the transmitting information collected by the step S07 into an utilization category, and to transform the utilization category and an using time into an using habit information. Specifically, the transmitting information includes a source address, a destination address, a source port, a destination port and a package feature information, moreover, the transmitting information can be applications used by the client U1 in different time point, package feature information and network traffic. The applications are divided into multiple utilization categories according to the data transmitting characteristic corresponding to the applications. For instance, the first utilization category can include game programs, meeting programs or other applications, which need to transmit the data immediately. The second utilization category can include multimedia audiovisual applications or other streaming serving applications with immediacy requirement lower than the first utilization category. The third utilization category can include data downloading or webpage browsing, but the present disclosure is not limited thereto.

The step S082 includes driving the controller C1 to determine whether the utilization category of the client U1 is corresponding to a priority level. Further, the application corresponding to the priority level is the application of the first utilization category, that is, the application with high data transmitting immediacy and high network traffic requirement. When the controller C1 determine that the utilization category of the client U1 is corresponding to the priority level, the step S083 is performed. The step S083 includes driving the controller C1 to read a previous using habit information of the client U1 in a corresponding time interval. The previous using habit information includes a plurality of previous utilization categories. The step S084 includes driving the controller C1 to compare whether at least one of the previous utilization categories of the previous using habit information is corresponding to the priority level. When at least one of the previous utilization categories of the previous using habit information is corresponding to the priority level, the step S085 is performed. The step S085 includes driving the controller C1 to determine whether a number of the at least one of the previous utilization categories corresponding to the priority level is greater than a default number, if the condition of the step S085 is true, the step S086 is performed. The step S086 includes driving the controller C1 to list the client U1 into a priority level list corresponding to a default time interval.

In detail, when the present utilization category of the client U1 is determined as a priority level, the step S083 is executed by the controller C1 to read the previous using state of the client U1. The using states of the client U1 in different time intervals are corresponding to different previous utilization categories. For example, the previous utilization of the client U1 in the last Monday to last Friday in the past week are all corresponding to the first utilization category, and the previous utilization of the client U1 in the last Saturday and Sunday in the past week are corresponding to the second utilization category. The step S084 is performed to verify whether the previous utilization categories in any of the time intervals is corresponding to the priority level, and the previous utilization category of the client U1 in 5:00 p.m. to 7:00 p.m. on Monday to Friday are corresponding to the priority level. The step S085 is performed to determine whether a number of the default time interval per day corresponding to the priority level is more than a default number. If the number of the default time interval per day corresponding to the priority level is more than the default number, that is, the transmitting behavior of the client U1 in the default time interval is regular. If the client U1 is verified to be transmitting data in the default time interval regularly, the step S086 is performed to list the client U1 into the priority list. Moreover, the default time interval can include a buffer time before or after the aforementioned time interval, in other words, the client U1 can use the application corresponding to the priority level regularly in the buffer time before or after the default time interval. Thus, the channel selecting method 200 of the present disclosure can add the client U1 using the application corresponding to the priority level into the channel selection, thereby, ensuring the network connecting quality of the client U1.

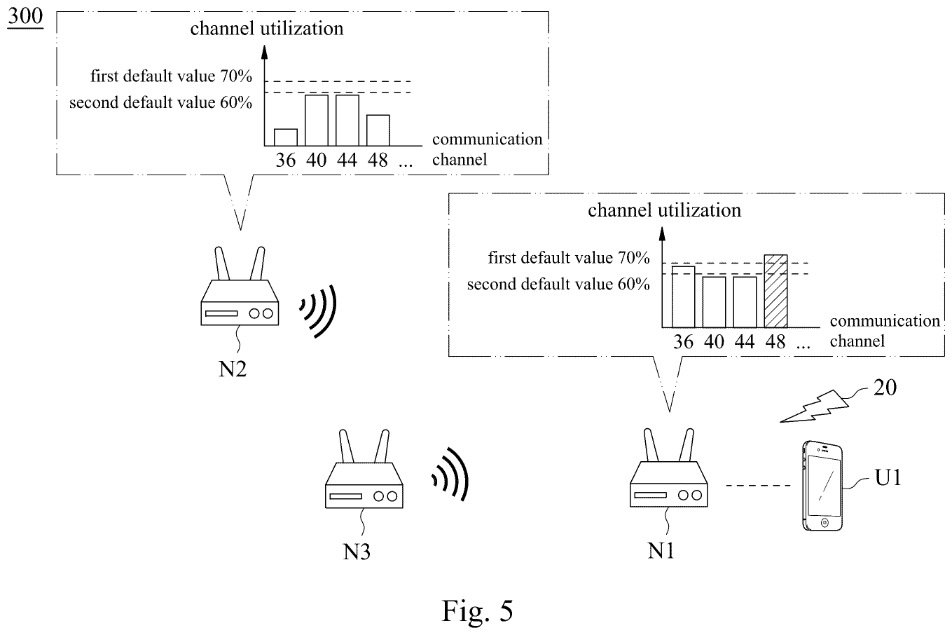

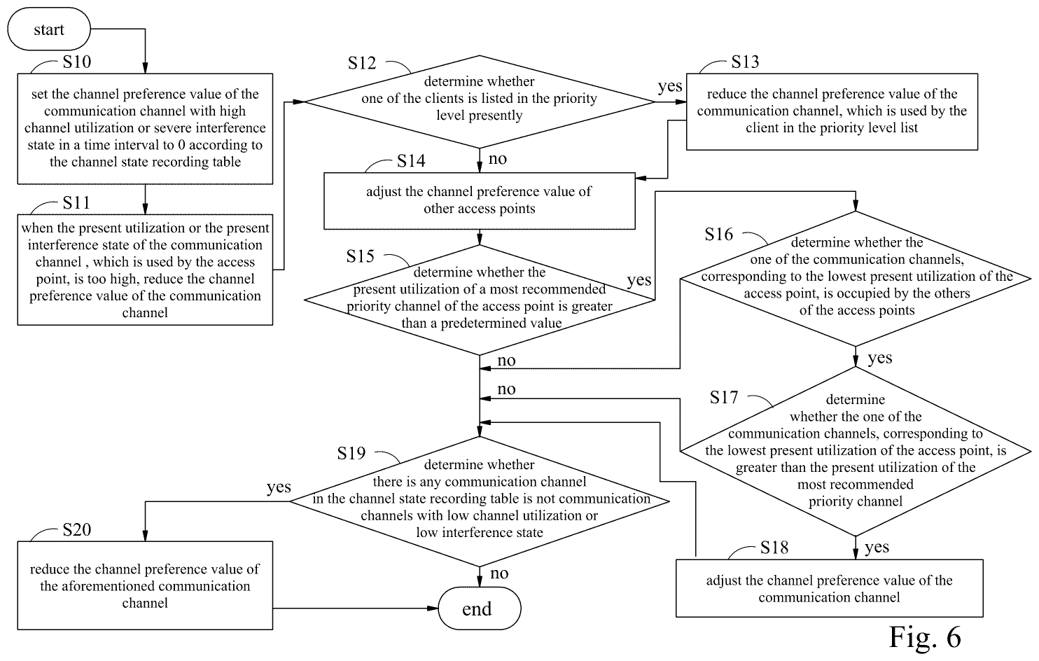

Please refer to FIG. 1, FIG. 5 and FIG. 6. FIG. 5 shows a schematic view of a channel selecting system 300 according to a third embodiment of the present disclosure. FIG. 6 shows a flow chart of the controller C1 of the channel selecting method 200 of FIG. 2, while adjusting the channel preference value. The channel selecting system 300 includes the controller C1 (shown in FIG. 1), the memory unit D1 (shown in FIG. 1), the access points N1, N2, N3, the client U1 and a plurality of communication channels 36, 40, 44, 48. The access point N1 transmits data with the client U1 through the communication channel 48, the access point N2 transmits data through the communication channel 40, and the access point N3 transmits data through the communication channel 44.

The channel selecting method 200 can further include the steps S10, S11, S12, S13, S14, S15, S16, S17, S18, S19, S20. Moreover, the channel selecting method 200 can adjust the channel preference values according to the present channel information of the access point N1 and the present channel information of the other access points N2, N3 in the mesh network structure through the steps S10, S11, S12, S13, S14, S15, S16, S17, S18, S19, S20. The step S10 is performed to set the channel preference value of the communication channel with high channel utilization or severe interference state in a time interval to 0 according to the channel state recording table T1. When the present utilization or the present interference state of the communication channel 48, which is used by the access point N1, is too high, the step S11 is performed to reduce the channel preference value of the communication channel 48. The step S12 is performed to determine whether one of the clients U1, U2, U3 is listed in the priority level presently. If the one of the clients U1, U2, U3 is listed in the priority level presently, the step S13 is performed, if none of the clients U1, U2, U3 is listed in the priority level presently, the step S14 is performed. The step S13 is performed to reduce the channel preference value of the communication channel 48, which is used by the client U1 in the priority level list. The step S14 is performed to adjust the channel preference value of other access points (the access points do not correspond to the priority level). The step S15 includes driving the controller C1 to determine whether the present utilization of a most recommended priority channel of the access point N1 is greater than a predetermined value. If the condition of the step S15 is true, the step S16 is performed, if the condition of the step S15 is false, the step S19 is performed. The most recommended priority channel is one of the communication channels 36, 40, 44, 48 with the highest channel preference values of the access point N1. When a number of the communication channels with the highest channel preference values is two, the two communication channels are both most recommended priority channels. The step S16 includes driving the controller C1 to determine whether the one of the communication channels, corresponding to the lowest present utilization of the access point N1, is occupied by the others of the access points (i.e., the access points N2, N3). If the condition of the step S16 is true, the step S17 is performed, if the condition of the step s16 is false, the step S19 is performed. The step S17 is performed to determine whether the one of the communication channels, corresponding to the lowest present utilization of the access point N1, is greater than the present utilization of the most recommended priority channel of any of the access points N2, N3. If the condition of the step S17 is true, the step S18 is performed, if the condition of the step S17 is false, the step S19 is performed. When the present utilization of the most recommended priority channel of any of the access points N2, N3 is less than the lowest present utilization of the access point N1, the step S18 is performed to adjust the channel preference value of the communication channel, using by one of the access points N2, N3, therefore, the channel preference value of the one of the access points N2, N3 is returned to the channel preference value before the step 14 is executed. The step S19 is performed to determine whether there is any communication channel in the channel state recording table T1 is not communication channels with low channel utilization or low interference state. If the condition of step S19 is true, the step S20 is performed. The step S20 is performed to reduce the channel preference value of the aforementioned communication channel.

Take FIG. 5 as example, the access point N1 and the client U1 are communicating through the communication channel 48. However, the communication channel 48 is interfered by an external interference 20, therefore, the present utilization of the communication channel 48 is more than a first default value (70%) of the Auto Channel Selection. The channel selecting method 200 of the present disclosure can verify whether any of the communication channels 36, 40, 44 having low channel utilization but being occupied by other access points or clients in the internal network is removed from the most recommended priority channel list. Then, the channel selecting method 200 of the present disclosure can coordinate the communication channels 36, 40, 44, 48, which are used by the access points N1, N2, N3 in the mesh network structure through the steps S15, S16, S17, S18, S19 in FIG. 6. For instance, when the step S15 determines a present utilization of the most recommended priority channel (i.e., the communication channel 36) of the access point N1 is more than the a second default value (60%), that is, the channel utilization of the communication channel 36 is close to the first default value (70%), the communication channel 36 is considered to be changed by other communication channel with lower channel utilization. The step S16 is performed to determine whether the communication channels 40, 44 with the lowest present utilization in the channel scanning result is occupied by other access points N2, N3. If the access points N2, N3 are using the communication channels 40, 44, the present utilization of the communication channels 40, 44 is caused by other access points in the internal mesh network, the communication channels 40, 44 are not occupied by access points or clients from external mesh network or encountering external interference. The step S17 is performed to determine whether the present utilization of the communication channels 40, 44, which has the lowest present utilization in the channel scanning result, is higher than a present utilization of the most recommended of any of the other access points N2, N3. If the condition of the step S17 is true, there are still some communication channels of the access point N2 or the access point N3 with low utilization can be used. Hence, one of the communication channels 40, 44 used by the access point N2 or the access point N3 can be vacated, and the access point N2 or the access point N3 can use other communication channels to communicate. Therefore, the access point N1 can switch to the most recommended priority channel (i.e., the communication channels 40, 44). Thus, the entire efficiency of the communication channels of the access points of the internal network can be average and stable. The channel preference values of the communication channels (i.e., the communication channels 40, 44) used by the access points N2, N3, which are corresponding to the aforementioned condition, are adjusted to the value before the step S14 is performed. Take FIG. 5 as an example, when the communication channel 48 of the access point N1 is interfered by an external interference 20, the access point N1 can be switched to use the communication channel 40 with lower present utilization, the access point N2 can be switched to use the communication channel 36 with the lowest present utilization, coordinates the communication channels (i.e., the communication channels 36, 40) used by the access points N1, N2, hence, both of the access points N1, N2 can have great communication quality. Thus, the channel selecting method 200 of the present disclosure can coordinate the channel selection against the entire using situation of the access points N1, N2, N3 in the mesh network structure.

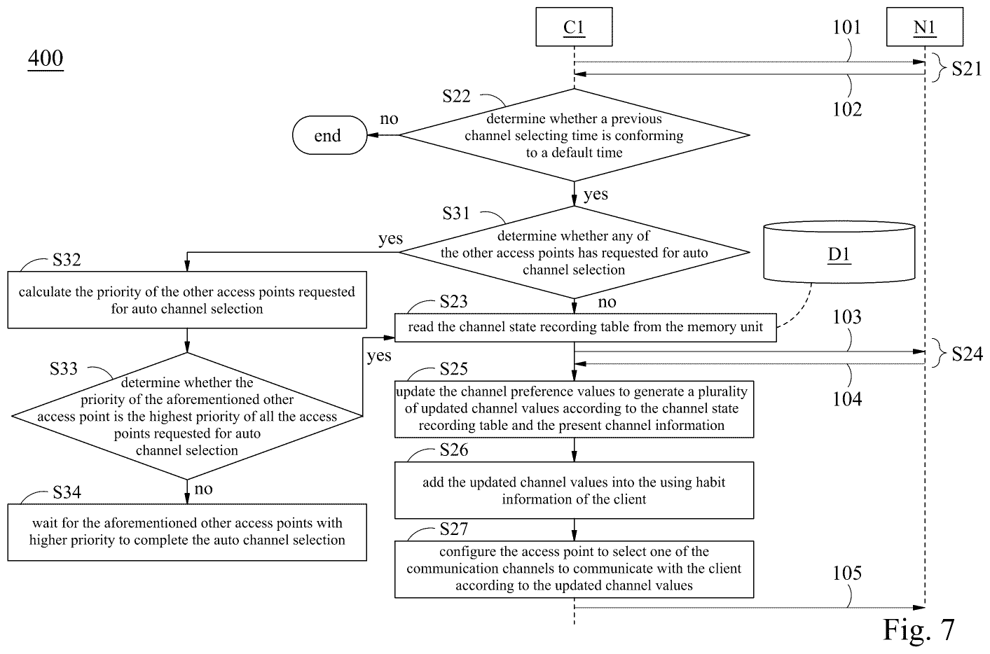

Please refer to FIG. 1, FIG. 2 and FIG. 7. FIG. 7 shows a flow chart of a channel selecting method 400 according to a fourth embodiment of the present disclosure. The channel selecting method 400 includes steps S21, S22, S23, S24, S25, S26, S27, S31, S32, S33, S34. In the channel selecting method 400, the steps S21, S22, S23, S24, S25, S27 are the same as the steps S01, S02, S03, S04, S05, S06 of the channel selecting method 200 in the second embodiment, and will not be described again. Specifically, the channel selecting method 400 can further include the steps S26, S31, S32, S33, S34. The step S26 is performed to add the updated channel values into the using habit information of the client. The step S31 is performed to determine whether any of the other access points (not shown in figures) has requested for auto channel selection. If the condition of the step S31 is true, the step S32 is performed, if the condition of the step S31 is false, the step S23 is performed. The step S32 is performed to calculate the priority of the other access points requested for auto channel selection. The step S33 is performed to determine whether the priority of the aforementioned other access point is the highest priority of all the access points requested for auto channel selection. If the condition of the step S33 is true, the step S23 is performed, if the condition of the step S33 is false, the step S034 is performed. The step S34 is performed to wait for the aforementioned other access points with higher priority to complete the auto channel selection. Thus, the channel selecting method 400 of the present disclosure can take the utilization category of the client in the specific time into consideration of auto channel selection, and increase the transmitting efficiency of the mesh network structure effectively.

In other embodiments of the present disclosure, the memory unit can further include a common list. A plurality of the channel state recording tables of all of the access points in the mesh network are read, at least one common channel state from the channel state recording tables is found to generate a common list. For example, more than half of the access points in the mesh network determine a channel preference value of one of the communication channels is 0, the channel preference value of the aforementioned communication channel is listed in the common list.

According to the aforementioned embodiments and examples, the advantages of the present disclosure are described as follows.

1. The channel selecting system of the present disclosure can select the best communication channel to communicate according to the previous state and present state of the communication channels, to increase the entire efficiency of the mesh network structure.

2. The channel selecting method of the present disclosure can add the client using the application corresponding to the priority level into the channel selection, thereby, ensuring the network connecting quality of the client.

3. The channel selecting method of the present disclosure can coordinate the channel selection against the entire using situation of the access points in the mesh network structure.

4. The channel selecting method of the present disclosure can take the utilization category of the client in the specific time into consideration of auto channel selection, and increase the transmitting efficiency of the mesh network structure effectively.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A channel selecting method, which is configured to communicate with a client, the channel selecting method comprising:
driving a controller to transmit a channel preference query message to an access point, and to configure the access point to return a plurality of channel preference values of the access point, wherein the channel preference values correspond to a plurality of communication channels;
driving the controller to determine whether a previous channel selecting time of the access point matches with a default time, wherein the previous channel selecting time is a time difference between a present time and a most recent time when the access point executes a channel selection;
driving the controller to read a channel state recording table from a memory unit when the previous channel selecting time matches with the default time, wherein the channel state recording table corresponds to a plurality of states of the communication channels;
driving the controller to scan the communication channels to obtain a present channel information, wherein the present channel information comprises a present utilization and a present interference state;
driving the controller to update the channel preference values to generate a plurality of updated channel values according to the channel state recording table and the present channel information; and
driving the controller to configure the access point to select one of the communication channels to communicate with the client according to the updated channel values.

2. The channel selecting method of claim 1, further comprising:
driving the controller to collect a transmitting information between the access point and the client; and
driving the controller to transform the transmitting information into an utilization category, and to transform the utilization category and an using time into an using habit information.

3. The channel selecting method of claim 1, wherein the channel state recording table comprises a previous utilization and a previous interference state of each of the communication channels.

4. The channel selecting method of claim 1, further comprising:
driving the controller to collect a present transmitting information of the client through the access point;
driving the controller to analyze an utilization category of the client according to the present transmitting information;
driving the controller to determine whether the utilization category of the client is corresponding to a priority level;
driving the controller to read a previous using habit information of the client when the utilization category of the client is corresponding to the priority level, wherein the previous using habit information comprises a plurality of previous utilization categories;
driving the controller to compare whether at least one of the previous utilization categories of the previous using habit information is corresponding to the priority level; and
driving the controller to list the client into a priority level list corresponding to a default time interval when a number of the at least one of the previous utilization categories corresponding to the priority level is greater than a default number.

5. The channel selecting method of claim 2, wherein the transmitting information comprises a source address, a destination address, a source port, a destination port and a package feature information.

6. The channel selecting method of claim 1, further comprising:
driving the controller to read a plurality of the channel state recording tables of a plurality of the access points, and to find at least one common channel state from the channel state recording tables to generate a common list.

7. The channel selecting method of claim 1, further comprising:
driving the controller to determine whether the present utilization of a most recommended priority channel of one of a plurality of the access points is greater than a predetermined value, wherein the most recommended priority channel is one of the communication channels with the highest one of the channel preference values of the one of the access point;
driving the controller to determine whether the one of the communication channels, corresponding to the lowest present utilization of the one of the access points, is occupied by the others of the access points when the present utilization of the most recommended priority channel of the one of the access points is greater than the predetermined value; and
driving the controller to determine whether the one of the communication channels, corresponding to the lowest present utilization of the one of the access points, is greater than the one of a plurality of the present utilizations of another most recommended priority channel of the others of the access points, when the one of the communication channels, corresponding to the lowest present utilization of the one of the access points, is occupied by the others of the access points.

8. A channel selecting system, which is configured to communicate with a client, the channel selecting system comprising:
an access point;
a memory unit comprising a channel state recording table, wherein the channel state recording table corresponds to a plurality of states of a plurality of communication channels; and
a controller signally connected to the access point and the memory unit, and configured to implement a channel selecting method comprising:
transmitting a channel preference query message to the access point, and configuring the access point to return a plurality of channel preference values of the access point, wherein the channel preference values correspond to the communication channels;
determining whether a previous channel selecting time of the access point matches with a default time, wherein the previous channel selecting time is a time difference between a present time and a most recent time when the access point executes a channel selection;
reading the channel state recording table from the memory unit when the previous channel selecting time matches with the default time;
scanning the communication channels to obtain a present channel information, wherein the present channel information comprises a present utilization and a present interference state;
updating the channel preference values to generate a plurality of updated channel values according to the channel state recording table and the present channel information; and
configuring the access point to select one of the communication channels to communicate with the client according to the updated channel values.

9. The channel selecting system of claim 8, wherein the controller is configured to implement the channel selecting method further comprising:
collecting a transmitting information between the access point and the client; and
transforming the transmitting information into an utilization category, and transforming the utilization category and an using time into an using habit information.

10. The channel selecting system of claim 8, wherein the channel state recording table comprises a previous utilization and a previous interference state of each of the communication channels.

11. The channel selecting system of claim 8, wherein the controller is configured to implement the channel selecting method further comprising:
collecting a present transmitting information of the client through the access point;
analyzing an utilization category of the client according to the present transmitting information;
determining whether the utilization category of the client is corresponding to a priority level;
reading a previous using habit information of the client when the utilization category of the client is corresponding to the priority level, wherein the previous using habit information comprises a plurality of previous utilization categories;
comparing whether at least one of the previous utilization categories of the previous using habit information is corresponding to the priority level; and
listing the client into a priority level list corresponding to a default time interval when a number of the at least one of the previous utilization categories corresponding to the priority level is greater than a default number.

12. The channel selecting system of claim 9, wherein the transmitting information comprises a source address, a destination address, a source port, a destination port and a package feature information.

13. The channel selecting system of claim 8, wherein the controller is configured to implement the channel selecting method further comprising:
reading a plurality of the channel state recording tables of a plurality of the access points, and finding at least one common channel state from the channel state recording tables to generate a common list.

14. The channel selecting system of claim 8, wherein the controller is configured to implement the channel selecting method further comprising:
determining whether the present utilization of a most recommended priority channel of one of a plurality of the access points is greater than a predetermined value, wherein the most recommended priority channel is one of the communication channels with the highest one of the channel preference values of the one of the access point;
determining whether the one of the communication channels, corresponding to the lowest present utilization of the one of the access points, is occupied by the others of the access points when the present utilization of the most recommended priority channel of the one of the access points is greater than the predetermined value; and
determining whether the one of the communication channels, corresponding to the lowest present utilization of the one of the access points, is greater than the one of a plurality of the present utilizations of another most recommended priority channel of the others of the access points, when the one of the communication channels, corresponding to the lowest present utilization of the one of the access points, is occupied by the others of the access points.
